(19) United States
(12) Patent Application Publication
(10) Pub. No.: US 2019/0333303 A1
(43) Pub. Date: Oct. 31, 2019

(54) PASSAGE AUTHORIZATION SYSTEM

(71) Applicant: HADASA GUTSHTANE, GIVAT ZEEV (IL)

(72) Inventor: HADASA GUTSHTANE, GIVAT ZEEV (IL)

(21) Appl. No.: 15/962,081

(22) Filed: Apr. 25, 2018

(51) Int. Cl. G07C 9/00; G06K 9/00; H04N 1/32

(52) U.S. Cl. CPC G07C 9/00158; G06K 9/00255; H04N 2201/3215; G06K 9/00771; H04N 1/32128; G06K 9/00288

(57) ABSTRACT

A passage authorization system, including a first camera, for producing a first picture containing a first and a second person appearing together, an image processor, for producing a second picture of the first person, and a third picture of the second person, both from the first picture, and a database for associating the second picture of the first person to a helpless person, and the third picture of the second person to a first caregiver of the helpless person, thereby authorizing the second person, as captures thereof conform to the third picture, to take the first person away.

### TECHNICAL FIELD

The invention relates to the field of gate passage security. More particularly, the invention relates to a system for ensuring that an authorized person takes a helpless person.

### BACKGROUND

The term “helpless person” refers herein to an infant or child or to any person being cared by a kindergarten or any other institution, being responsible thereto.

There is a long felt need to ensure, by technological means, that the father or mother or an authorized person only, is taking the infant from the kindergarten.

### BRIEF DESCRIPTION OF THE DRAWINGS

Embodiments, features, and aspects of the invention are described herein in conjunction with the following drawings in which:

FIG. 1 depicts the steps of registering a helpless person into a database;

FIG. 2 depicts the steps of taking away the helpless person of FIG. 1, based on the registering steps of FIG. 1;

FIG. 3 depicts the steps of confirming the authorization of the exiting;

FIG. 4 depicts the steps of registering a second caregiver to the helpless person of FIG. 1; and

FIG. 5 depicts supervision steps, which may be applied by the recording system of FIG. 1.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

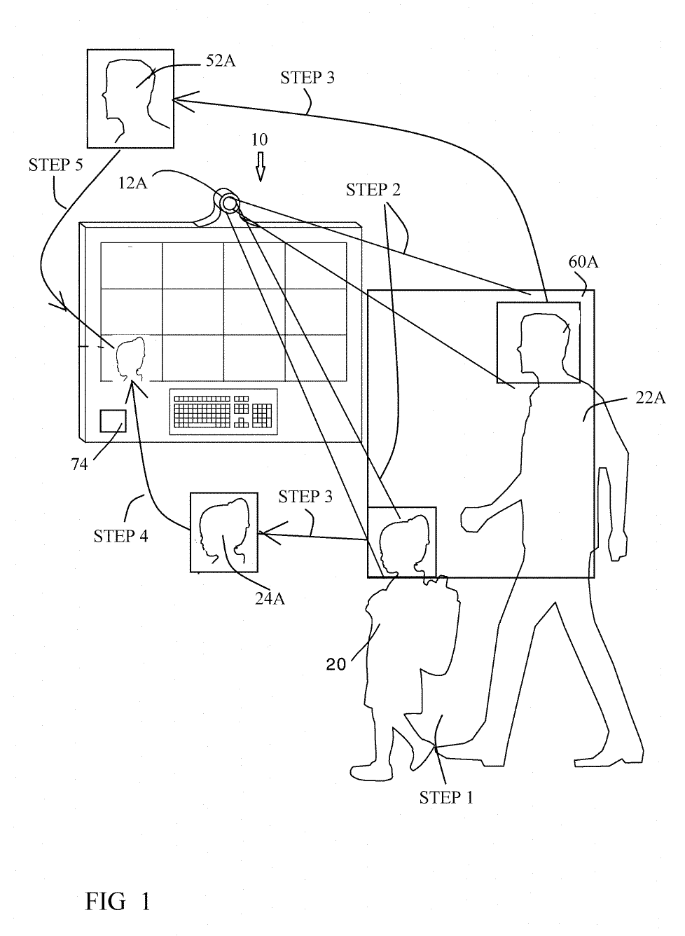

FIG. 1 depicts the steps of registering a helpless person into a database.

A caring institute for caring helpless persons, such as a kindergarten, retirement home, hospital, and the such, may operate a recording system 10, for recording any entering or exiting of the helpless persons, such as of the infants 20A.

The following description assumes that prior to the first step, the database 50 of recording system 10 is empty.

At the first step, the first helpless person 20A arrives with a caregiver, such as with the father 22A thereof, to the caring institute, such as to the kindergarten.

At the second step, a camera 12A of recording system 10 produces a picture 60A of helpless person 20A together with caregiver 22A.

At the third step, an image processor 74 of recording system 10 distinguishes between helpless person 20A and caregiver 22A, for instance as a function of their different height, and produces a picture 24A of helpless person 20A, and a picture 52A of caregiver 22A, both from picture 60A.

At the fourth step, recording system 10 registers helpless person 20A into database 50, by attaching picture 24A.

At the fifth step, recording system 10 registers caregiver 22A for helpless person 20A into database 50, and associates picture 52A to picture 24A. This step authorizes caregiver 22A for helpless person 20A only.

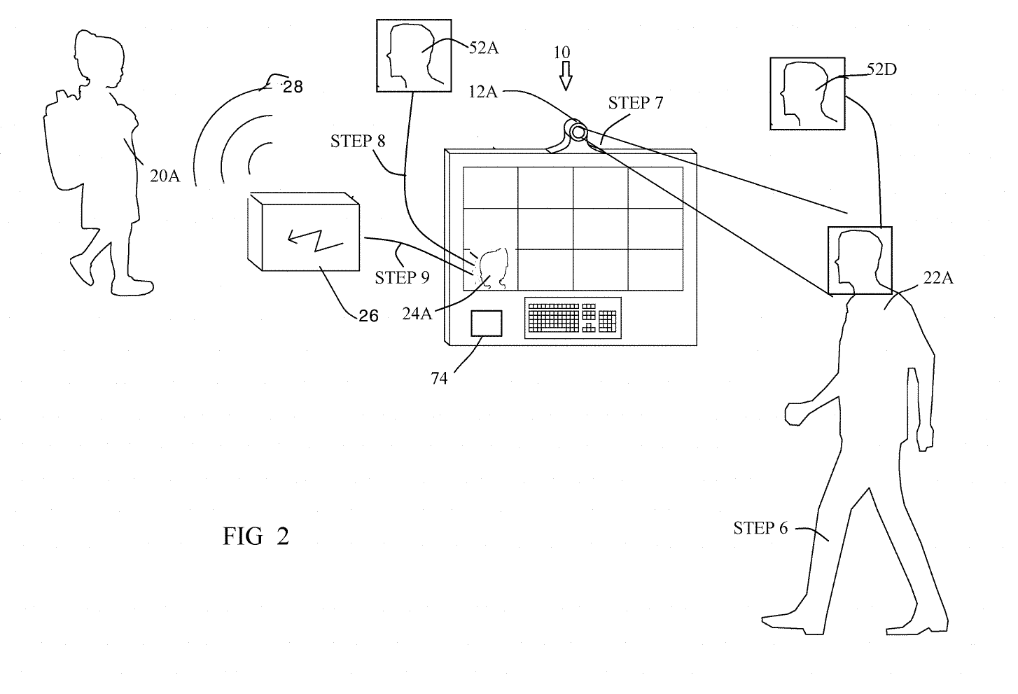

FIG. 2 depicts the steps of taking away the helpless person of FIG. 1, based on the registering steps of FIG. 1.

At the sixth step, caregiver 22A comes alone, for taking helpless person 20A back.

At the seventh step, camera 12A and image processor 74 confirm that the current picture 52D of caregiver 22A conforms to picture 52A.

At the eighth step, recording system 10 finds that picture 24A is associated with picture 52A, and at the ninth step, announces, such as by a loudspeaker 26, the authorization to pass and take away helpless person 20A.

Otherwise, at the eighth step, recording system 10 finds that picture 24A is not associated with picture 52A, and at the ninth step, may alert, such as by a loudspeaker 26, that this person is not authorized, or even that this is a non-authorized attempt to pass and take away helpless person 20A.

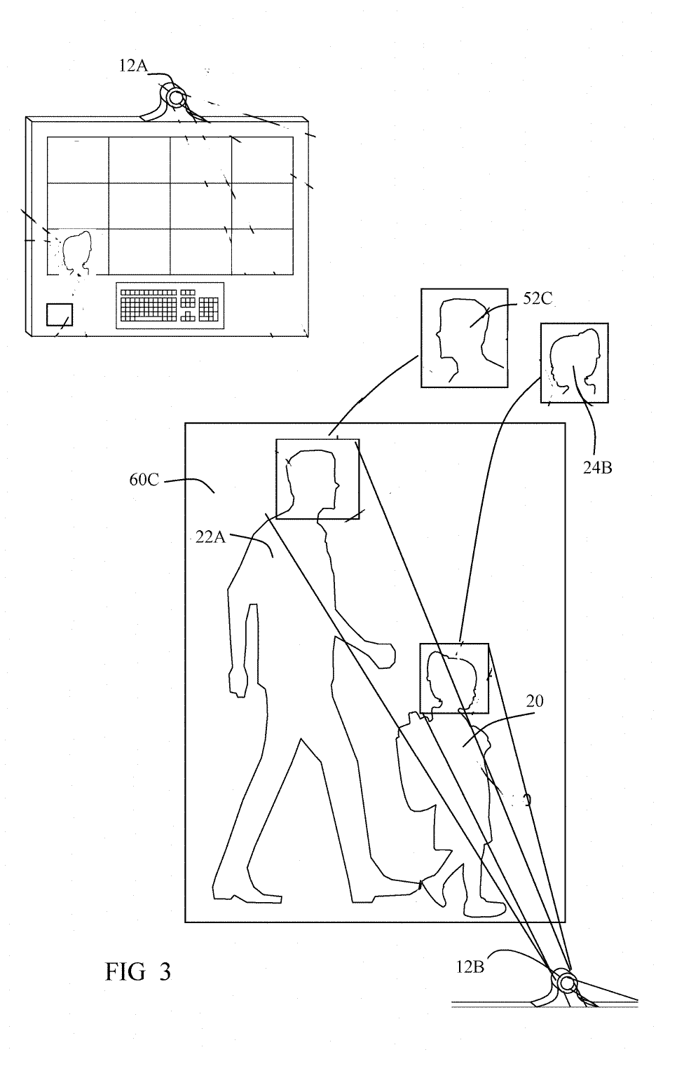

FIG. 3 depicts the steps of confirming the authorization of the exiting.

At the positive case, camera 12B may capture caregiver 22A and helpless person 20A once exiting, for confirming the authorization of the exiting and for providing evidence of the exiting.

In detail, camera 12B may produce a picture 60C of helpless person 20 and caregiver 22A appearing together, during the taking away of helpless 20. Then, image processor 74 produces a picture 24B of helpless person 20 and a picture 52C caregiver 22A, both from picture 60C. Then database 50 confirms that picture 24B conforms to picture 24A of FIG. 1, and that picture 52C conforms to picture 52A of FIG. 1.

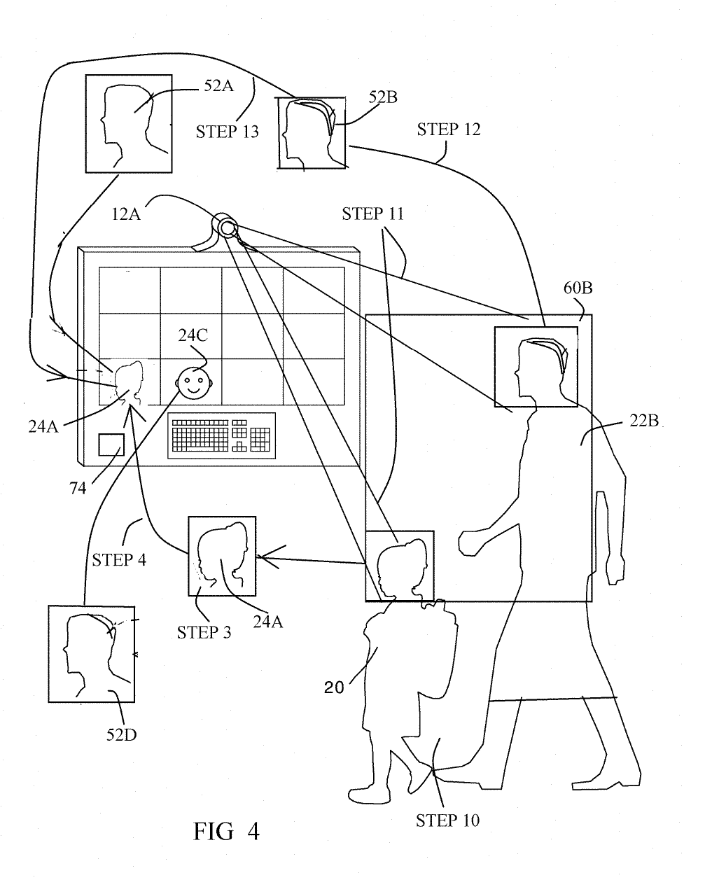

FIG. 4 depicts the steps of registering a second caregiver to the helpless person of FIG. 1.

At the tenth step, first helpless person 20A arrives with a new caregiver, such as with the mother 22B thereof.

At the eleventh step, camera 12A produces a picture 60B of helpless person 20A together with caregiver 22B.

At the twelfth step, image processor 74 distinguishes between helpless person 20A and caregiver 22B, and produces a picture 52B of caregiver 22B from picture 60B.

At the thirteenth step, recording system 10 registers caregiver 22B for helpless person 20A into database 50, and associates picture 52B as well to picture 24A. This step authorizes caregiver 22B, in addition to caregiver 22A, for helpless person 20A only.

At the fourteenth step, recording system 10 indicates picture 24A as arrived to the kindergarten, for allowing taking him away.

Then at the next step (not shown), any of caregivers 22A or 22B are authorized to take helpless person 20A.

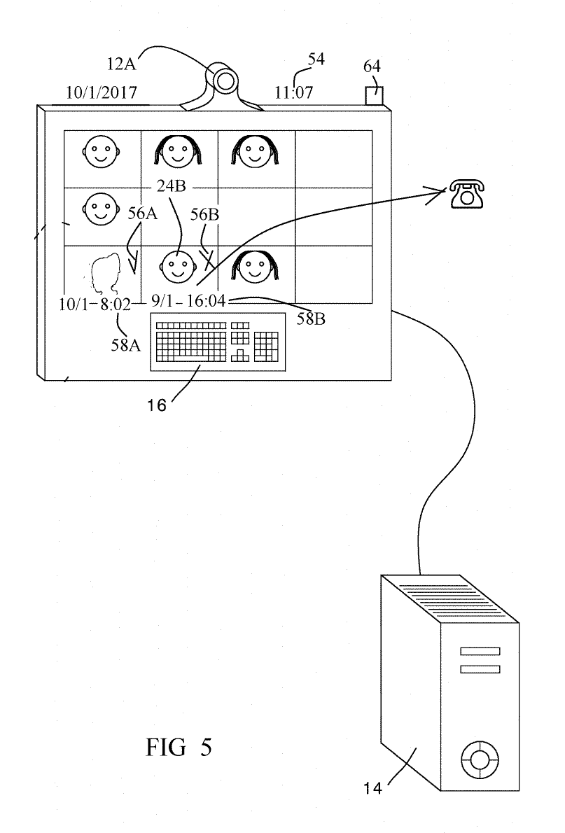

FIG. 5 depicts supervision steps, which may be applied by the recording system of FIG. 1.

The time of each entrance and exit is recorded into database 16 by a clock 64, for being handled. For example, the current time 54 is 11:07 of date Oct. 1, 2017; and the status of the helpless person having picture 24A is entrance 56A at time 58A of 8:02 of date Oct. 1, 2017, i.e. a recent entrance; and the status of the helpless person having picture 24B is exit 56B at time 58B of 16:04 of date Sep. 1, 2017, i.e. left yesterday, and did not arrive yet today.

In this case the system will induce a phone call to the caregiver of the helpless person having picture 24B.

According to another embodiment, the system may associate the caregiver to the helpless person via a barcode or via fingerprints.

Thus, in one aspect, the invention is directed to a passage authorization system (10), including:

a first camera (12A), for producing a first picture (60A) containing a first (20) and a second (22A) person appearing together;

an image processor (74), for producing a second picture (24A) of the first person (20), and a third picture (52A) of the second person (22A), both from the first picture (60A); and

a database (50) for associating
the second picture (24A) of the first person (20) to a helpless person, and
the third picture (52A) of the second person (22A) to a first caregiver of the helpless person,

thereby authorizing (28) the second person (22A), as captures thereof conform to the third picture (52A), to take the first person (20) away.

The first camera (12A) may further be applied for producing a fourth picture (60B) containing the first person (20) and a third (22B) person appearing together, and

wherein the image processor (74) is further configured for producing a fifth picture (52B) of the third person (22B) from the fourth picture (60B), and

the database (50) is further configured for associating the fifth picture (52B) of the third person (22B) to a second caregiver of the helpless person,

thereby authorizing, in addition to the second person (22A), also the third person (22B), as captures thereof conform to the fifth picture (52B), to take the first person (20) away.

The passage authorization system (10) may further include a clock (64), for recording time (58A) of producing the first picture (60A) as an entrance time.

The clock (64) may further be applied for recording time (58B) once the second person (22A) takes the first person (20) away.

The passage authorization system (10) may further include:

a second camera (12B), for producing a sixth picture (60C) containing the first (20) and second (22A) persons appearing together, during the taking away of the first person (20),

and the image processor (74) may further be applied for producing a seventh picture (24B) of the first person (20), and an eighth picture (52C) of the second person (22A), both from the sixth picture (60C),

wherein the database (50) is further configured for confirming that the seventh picture (24B) conforms to the second picture (24A), and that the eighth picture (52C) conforms to the third picture (52A),

thereby confirming application of the authorization.

In the figures and/or description herein, the following reference numerals (Reference Signs List) have been mentioned:
numeral 10 denotes the recording system, named also passage authorization system, according to one embodiment of the invention;
numeral 12A denotes a camera, for capturing persons requesting to enter;
numeral 12B denotes a camera, for capturing exiting persons;
numeral 14 denotes a server;
numeral 16 denotes a database;
numeral 20 denotes the helpless person;
numerals 22A and 22B denote caregivers;
numerals 24A, 24B and 24C denote pictures of helpless persons, each cut from a larger picture;
numeral 26 denotes a loudspeaker;
numeral 28 denotes an authorization announcement;
numerals 52A, 52B 52C, and 52D denote pictures of caregivers, each cut from a larger picture; and
numerals 60A, 60B and 60C denote pictures produced by the camera.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A passage authorization system, comprising:
a first camera, for automatically producing a first picture containing a first and a second person upon appearing together;
an image processor, for automatically producing a second picture of said first person, and a third picture of said second person, both from said first picture, upon said producing thereof; and
a database for automatically, upon said producing of said second and third pictures, associating
said second picture of said first person to a helpless person, and
said third picture of said second person to a first caregiver of said helpless person,
thereby automatically authorizing said second person, as captures thereof conform to said third picture, to pass said first person.

2. A passage authorization system according to claim 1,
wherein said first camera is further configured for producing a fourth picture containing said first person and a third person appearing together,
wherein said image processor is further configured for producing a fifth picture of said third person from said fourth picture, and
wherein said database is further configured for associating said fifth picture of said third person to a second caregiver of said helpless person,
thereby authorizing, in addition to said second person, also said third person, as captures thereof conform to said fifth picture, to pass said first person.

3. A passage authorization system according to claim 1, further comprising:
a clock, for recording time of producing said first picture as an entrance time.

4. A passage authorization system according to claim 3, wherein said clock is further configured for recording time once said second person pass said first person.

5. A passage authorization system according to claim 1, further comprising:
a second camera, for producing a sixth picture containing said first and second persons appearing together, during said passing of said first person,
wherein said image processor is further configured for producing a seventh picture of said first person, and an eighth picture of said second person, both from said sixth picture, and
wherein said database is further configured for confirming that said seventh picture conforms to said second picture, and that said eighth picture conforms to said third picture, thereby confirming application of said authorization.
